(19) United States
(12) Patent Application Publication
(10) Pub. No.: US 2024/0291732 A1
(43) Pub. Date: Aug. 29, 2024

(54) MANAGING NOTIFICATIONS IN A WIRELESS NETWORK

(71) Applicant: RAKUTEN MOBILE, INC., Tokyo (JP)

(72) Inventors: Abhishek GADEKAR, Indore (IN); Abhinav DWIVEDI, Indore (IN); Kundan KAUSHIK, Indore (IN); Bakir MALAK, Indore (IN)

(73) Assignee: RAKUTEN MOBILE, INC., Tokyo (JP)

(21) Appl. No.: 18/042,370

(22) PCT Filed: Jan. 23, 2023
(86) PCT No.: PCT/US2023/011305

§ 371 Date: Feb. 21, 2023

(30) Foreign Application Priority Data
Dec. 9, 2022 (IN) 202241071136

(51) Int. Cl. H04L 41/5009; H04L 41/22

(52) U.S. Cl. CPC H04L 41/5009; H04L 41/22

(57) ABSTRACT

Embodiments herein disclose a method and centralized system for managing notifications in a wireless network. The method further includes building, by the centralized system, a plurality of performance notification rules or at least one ominidesk notification rule by a plurality of target devices to receive notification from a plurality of network nodes in the wireless network. The method further includes receiving, by the centralized system, KPI information or a plurality of user posts from at least one network node of the plurality of network nodes. The method further includes validating, by the centralized system, the KPI information or the plurality of user posts based on the plurality of performance notification rules or the at least one ominidesk notification rule. The method further includes sending, by the centralized system, a notification comprising the KPI information or validated user posts to the at least one target device.

### CROSS REFERENCE TO RELATED APPLICATION

The present application claims priority to Indian provisional application 202241071136, filed on Dec. 9, 2022, the content of which is hereby expressly incorporated by reference, in its entirety, into the present application.

### FIELD OF INVENTION

The embodiments herein relate to a centralized system and more particularly relate to a method and a centralized system for managing notifications in a wireless network.

### BACKGROUND OF THE INVENTION

Generally, a computing device connects to several network nodes such as different modules, software applications, and databases that produce notifications. The notification pop-up on a display screen to provide information or a reminder to users. The form of these notifications and the manner in which they appear on a user's display screen is generally determined by designers of the network nodes. The users will get a variety and number of notifications so overwhelming that the user may eventually choose to disable all notifications, therefore chances of missing some important notification is high.

In conventional systems, the variety and number of notifications are managed by managing the notification separately at each of the network nodes based on the user's preferences which consumes more time for configuring separately at each of the network nodes. Further, in the conventional system, the user has difficulty accessing and tracking the notification as the user receives a number of notifications.

Hence, there is a high demand for a centralized system for managing notifications from the network nodes.

### OBJECT OF INVENTION

The principal object of the embodiments herein is to provide a method and centralized system for managing notification centrally in a wireless network which reduces time in configuring user's preferences separately at network nodes.

Another object of the embodiments herein is to validate the Key Performance Indicator information of network nodes based on a plurality of performance notification rules corresponding to network nodes and sends a notification in response to successful validation of the KPI information to target devices which helps to monitor the performance of the network nodes with a centrally configured performance notification rules at the centralized system.

Another object of the embodiments herein is to validate the plurality of user posts received from the network nodes based on ominidesk notification rules and send a notification comprising the validated user posts to the target devices in response to successful validation which saves time in filtering content present in the network nodes.

### SUMMARY

Accordingly, the embodiments herein disclose a centralized system for managing notifications in a wireless network. The centralized system comprises: a memory; and a processor, communicatively coupled to the memory. The processor is configured to build a plurality of network performance notification rules by a plurality of target devices to receive notification from a plurality of network nodes in the wireless network. The processor is further configured to store the plurality of network performance notification rules in a performance notification rule database and receive a plurality of network performance notifications from a plurality of network nodes. The processor is further configured to retrieve at least one network performance notification rule from the plurality of network performance notification rules stored in the performance notification rule database. The processor is further configured to validate the plurality of received network performance notifications based on the at least one performance notification rule. The processor is further configured to send at least one network performance notification from the plurality of received network performance notifications to at least one target device from the plurality of target devices that build the at least one network performance notification rule in response to successful validation of the at least one network performance notification.

Accordingly, the embodiments herein disclose the centralized system for managing notifications in the wireless network. The centralized system comprises: the memory; and the processor, communicatively coupled to the memory. The processor is configured to build a plurality of ominidesk notification rules by at least one target device to user post from a plurality of network nodes in the wireless network. The processor is further configured to store the plurality of ominidesk notification rules in an ominidesk notification rule database. The processor is further configured to receive a plurality of user posts from at least one network node of the plurality of network nodes. The processor is further configured to retrieve at least one ominidesk notification rule from the plurality of ominidesk notification rules stored in the ominidesk notification rule database. The processor is further configured to validate the plurality of user posts based on the at least one ominidesk notification rule. The processor is further configured to send a notification comprising the validated user posts to at least one target device in response to successful validation.

Accordingly, the embodiments herein disclose a method for managing notification in the wireless network by the centralized system comprises: building, by the centralized system, the plurality of network performance notification rules by the plurality of target devices to receive notification from the plurality of network nodes in the wireless network. The method further includes storing, by the centralized system, the plurality of network performance notification rules in the performance notification rule database. The method further includes receiving, by the centralized system, the plurality of network performance notifications from the plurality of network nodes. The method further includes retrieving, by the centralized system, at least one network performance notification rule from the plurality of network performance notification rules stored in the performance notification rule database. The method further includes validating, by the centralized system, the plurality of received network performance notifications based on the at least one performance notification rule. The method further includes sending, by the centralized system, at least one network performance notification from the plurality of received network performance notifications to at least one target device from the plurality of target devices that build the at least one network performance notification rule in response to successful validation of the at least one network performance notification.

Accordingly, the embodiments herein disclose a method for managing notification in the wireless network by the centralized system comprises: building, by the centralized system, the plurality of ominidesk notification rules by at least one target device to user post from the plurality of network nodes in the wireless network. The method further includes storing, by the centralized system, the plurality of ominidesk notification rules in an ominidesk notification rule database. The method further includes receiving, by the centralized system, the plurality of user posts from at least one network node of the plurality of network nodes. The method further includes retrieving, by the centralized system, at least one ominidesk notification rule from the plurality of ominidesk notification rules stored in the ominidesk notification rule database. The method further includes validating, by the centralized system, the plurality of user posts based on the at least one ominidesk notification rule. The method further includes sending, by the centralized system, the notification comprising the validated user posts to at least one target device in response to successful validation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram of a centralized system for managing notification in a wireless network, according to the embodiments as disclosed herein;

FIG. 2 is a block diagram of the centralized system illustrating communication with plurality of network nodes, according to the embodiments as disclosed herein;

FIG. 3A is a flow chart illustrating managing notification in the wireless network with a performance notification rule, according to the embodiments as disclosed herein;

FIG. 3B is a flow chart illustrating managing notification in the wireless network with a ominidesk notification rule, according to the embodiments as disclosed herein;

FIG. 4 is a flow chart illustrating a generation of notifications related to network performance, according to the embodiments as disclosed herein;

FIG. 5 is a flow chart illustrating the generation of notifications related to posts posted in social media using omnidesk notification rules, according to the embodiments as disclosed herein;

FIG. 6 is a schematic diagram illustrating a user interface of the centralized system while configuring the network performance rules, according to the embodiments as disclosed herein; and

FIG. 7 is a schematic diagram illustrating the user interface of the centralized system while configuring the ominidesk notification rules, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be constructed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose a centralized system for managing notifications in a wireless network. The centralized system comprises: a memory; and a processor, communicatively coupled to the memory. The processor is configured to build a plurality of network performance notification rules by a plurality of target devices to receive notification from a plurality of network nodes in the wireless network. The processor is further configured to store the plurality of network performance notification rules in a performance notification rule database and receive a plurality of network performance notifications from a plurality of network nodes. The processor is further configured to retrieve at least one network performance notification rule from the plurality of network performance notification rules stored in the performance notification rule database. The processor is further configured to validate the plurality of received network performance notifications based on the at least one performance notification rule. The processor is further configured to send at least one network performance notification from the plurality of received network performance notifications to at least one target device from the plurality of target devices that build the at least one network performance notification rule in response to successful validation of the at least one network performance notification.

Accordingly, the embodiments herein disclose the centralized system for managing notifications in the wireless network. The centralized system comprises: the memory; and the processor, communicatively coupled to the memory. The processor is configured to build a plurality of ominidesk notification rules by at least one target device to user post from a plurality of network nodes in the wireless network. The processor is further configured to store the plurality of ominidesk notification rules in an ominidesk notification rule database. The processor is further configured to receive a plurality of user posts from at least one network node of the plurality of network nodes. The processor is further configured to retrieve at least one ominidesk notification rule from the plurality of ominidesk notification rules stored in the ominidesk notification rule database. The processor is further configured to validate the plurality of user posts based on the at least one ominidesk notification rule. The processor is further configured to send a notification comprising the validated user posts to at least one target device in response to successful validation.

Accordingly, the embodiments herein disclose a method for managing notification in the wireless network by the centralized system comprises: building, by the centralized system, the plurality of network performance notification rules by the plurality of target devices to receive notification from the plurality of network nodes in the wireless network. The method further includes storing, by the centralized system, the plurality of network performance notification rules in the performance notification rule database. The method further includes receiving, by the centralized system, the plurality of network performance notifications from the plurality of network nodes. The method further includes retrieving, by the centralized system, at least one network performance notification rule from the plurality of network performance notification rules stored in the performance notification rule database. The method further includes validating, by the centralized system, the plurality of received network performance notifications based on the at least one performance notification rule. The method further includes sending, by the centralized system, at least one network performance notification from the plurality of received network performance notifications to at least one target device from the plurality of target devices that build the at least one network performance notification rule in response to successful validation of the at least one network performance notification.

Accordingly, the embodiments herein disclose a method for managing notification in the wireless network by the centralized system comprises: building, by the centralized system, the plurality of ominidesk notification rules by at least one target device to user post from the plurality of network nodes in the wireless network. The method further includes storing, by the centralized system, the plurality of ominidesk notification rules in an ominidesk notification rule database. The method further includes receiving, by the centralized system, the plurality of user posts from at least one network node of the plurality of network nodes. The method further includes retrieving, by the centralized system, at least one ominidesk notification rule from the plurality of ominidesk notification rules stored in the ominidesk notification rule database. The method further includes validating, by the centralized system, the plurality of user posts based on the at least one ominidesk notification rule. The method further includes sending, by the centralized system, the notification comprising the validated user posts to at least one target device in response to successful validation.

In conventional systems, the variety and number of notifications are managed by managing the notification separately at each of the network nodes s with the user's preferences which consumes more time for configuring separately at each of the network nodes. Further, in the conventional system, the user has difficulty accessing and tracking the notification as the user receives a number of notifications. Unlike conventional systems, the proposed system and method can manage notifications from the network nodes centrally which reduces time in configuring user's preferences separately at network nodes.

Unlike conventional systems, the proposed system and method remove the difficulty in accessing and tracking the notification from the network nodes.

Unlike conventional systems, the proposed system and method validates the KPI information of network nodes based on the plurality of performance notification rules corresponding to network nodes and sends a notification in response to successful validation of the KPI information to target devices which helps to monitor the performance of the network nodes.

Unlike conventional systems, the proposed system and method validates the plurality of user posts receive from the network nodes based on ominidesk notification rules and sends a notification comprising the validated user posts to the target devices in response to successful validation which saves time in filtering content present in the network nodes.

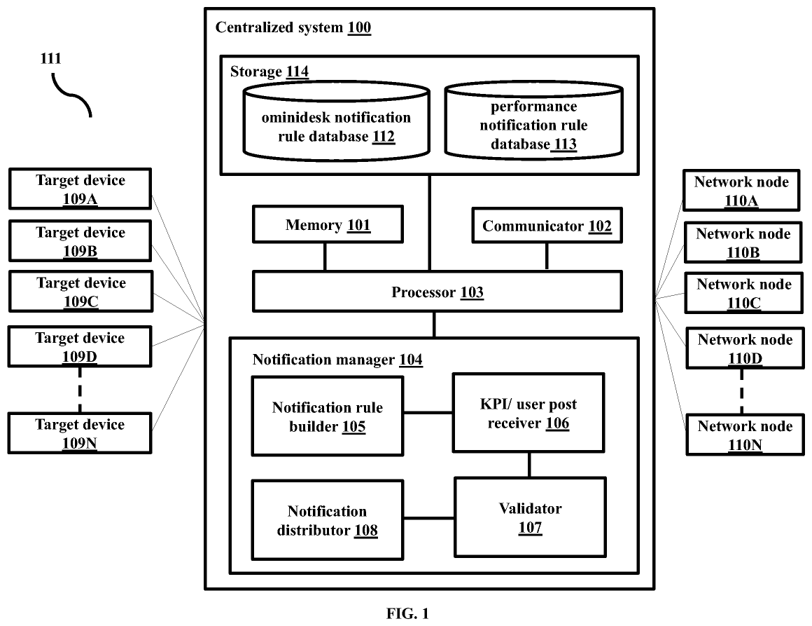

Referring now to the drawings, and more particularly to FIG. 1 through FIG. 7, there are shown preferred embodiments.

FIG. 1 is a block diagram of a centralized system (100) for managing notification in a wireless network (111), according to the embodiments as disclosed herein.

Referring to FIG. 1, examples of the centralized system (100) include but are not limited to a laptop, a palmtop, a desktop, a mobile phone, a smartphone, Personal Digital Assistant (PDA), a tablet, a wearable device, an Internet of Things (IoT) device, a virtual reality device, a foldable device, a flexible device, an immersive system, etc.

In an embodiment, the centralized system (100) includes a memory (101), a processor (102) a communicator (103), storage (114) and a notification manager (104).

The memory (101) stores instructions to be executed by the processor (102) for managing notifications in the wireless network (111). The memory (101) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (101) may, in some examples, be considered a non-transitory storage medium. The term “non-transitory” may indicate that the storage medium is not embodied in a carrier wave or a propagated signal. However, the term “non-transitory” should not be interpreted that the memory (101) is non-movable. In some examples, the memory (101) can be configured to store larger amounts of information than its storage space. In certain examples, a non-transitory storage medium may store data that can, over time, change (e.g., in Random Access Memory (101) (RAM) or cache). The memory (101) can be an internal storage unit or it can be an external storage unit of the electronic device (100), a cloud storage, or any other type of external storage.

The processor (102) is configured to execute instructions stored in the memory (101). The processor (102) may be a general-purpose processor (102), such as a Central Processing Unit (CPU), an Application Processor (AP), or the like, a graphics-only processing unit such as a Graphics Processing Unit (GPU), a Visual Processing Unit (VPU) and the like. The processor (102) may include multiple cores to execute the instructions.

The communicator (103) is configured for communicating internally between hardware components in the centralized system (100). Further, the communicator (103) is configured to facilitate communication between the centralized system (100) and other devices via one or more networks (e.g. Radio technology). The communicator (103) includes an electronic circuit specific to a standard that enables wired or wireless communication.

The processor (102) is coupled with the graphical representation generator and the graphical representation generator is implemented by processing circuitry such as logic gates, integrated circuits, microprocessors, microcontrollers, memory (101) circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The storage (114) in the centralized system (100) includes an ominidesk notification rule database (112) and a performance notification rule database (113) and the storage (114) is connected to the processor.

The centralized system (100) includes a notification manager (104) which is coupled with the processor (102) and comprises a notification rule builder (105), a KPI/user post receiver (106), a validator (107), notification distributor (108).

The notification rule builder (105) builds a plurality of network performance notification rules by a plurality of target devices (109A-109N) to receive notification from a plurality of network nodes (110A-110N) in the wireless network (111). The processor (102) is further configured to store the plurality of network performance notification rules in a performance notification rule database (113) and receive a plurality of network performance notifications from a plurality of network nodes (110A-110N). The KPI/user post receiver (106) retrieves at least one network performance notification rule from the plurality of network performance notification rules stored in the performance notification rule database (113). The Validator (107) validates the plurality of received network performance notifications based on the at least one performance notification rule. The Notification distributor (108) sends at least one network performance notification from the plurality of received network performance notifications to at least one target device from the plurality of target devices (109A-109N) that build the at least one network performance notification rule in response to successful validation of the at least one network performance notification.

The processor (102) is configured to display a performance notification rule building interface comprising a network node parameter field to select network node for which the performance notification rule need to be build. The processor (102) is further configured to receive an input in the network node parameter field from the at least one target device, wherein the input indicates the selection of the at least one network node form the plurality of nodes for which the performance notification rule need to be build. The processor (102) is further configured to display, in the performance notification rule building interface, a plurality of rule building parameters for the at least one selected network node, at least one KPI parameter supported by the at least one selected network node and an execution level for the at least one selected network node. The processor (102) is further configured to receive input from the at least one target device corresponding to each rule building rule parameter from the plurality of rule building parameters, the at least one KPI parameter supported by the at least one selected network node, and the execution level for the at least one selected network node. The processor (102) is further configured to automatically generate at least one network performance notification rule for the at least one selected network node based on the received input corresponding to each rule building rule parameter from the plurality of rule building parameters, the KPI parameter supported by the at least one selected network node.

In an embodiment, the plurality of rule building parameters are different for different network nodes (110A-110N), and wherein the plurality of rule building parameters are dynamically displayed based on the selection of the network node.

The processor (102) is configured to detect an execution level for each network performance notification of the plurality of network performance notifications. The processor (102) is further configured to group a set of performance notification of the plurality of network performance notifications having the same execution level information into a group. The processor (102) is further configured to detect at least one network node from the plurality of network nodes (110A-110N) for the execution level and the group of performance notifications. The processor (102) is further configured to retrieve KPI information from the at least one detected network node for the execution level.

The processor (102) is configured to validate the plurality of received network performance notifications and the KPI information from the at least one detected network node based on the at least one performance notification rule.

The processor (102) is configured to generate a notification report for at least one network performance notification from the plurality of received network performance notifications and the KPI information from the at least one detected network node in response to in response to unsuccessful validation.

The processor (102) is configured to determine parameters in a report frequency information section and a notification report medium section of the at least one performance notification rule. The processor (102) is further configured to determine the at least one target device from the plurality of target device associated with the KPI information corresponding to the at least one network performance notification rule. The processor (102) is further configured to send at least one network performance notification comprising the KPI information to the at least one target device from the plurality of target devices (109A-109N) in accordance with the parameters in the report frequency information section and the notification report medium section.

In an embodiment the plurality of rule building parameters comprises the report frequency section, the notification report medium section, a location section, a notification assignment section and at least one target devices (109A-109N) details parameter for sending the notification. The report frequency section includes fields comprising hours basis, daily basis, weekly basis, wherein the notification report medium section includes fields comprising SMS, Email, messengers, wherein the location section includes fields comprising region, city, cluster, equipment type, wherein the notification assignment section includes fields comprising channel name and channel URL.

In an embodiment the at least one KPI parameter rule building parameters comprises a basic information parameters and a KPI selection parameters, wherein the basic information parameters includes fields comprising execution type, domain, technology, vendor, node and execution level, wherein the KPI selection parameters includes fields comprises KPI name and KPI group.

The notification rule builder (105) builds a plurality of ominidesk notification rules by at least one target device to user post from the plurality of network nodes (110A-110N) in the wireless network (111). The processor (102) is further configured to store the plurality of ominidesk notification rules in an ominidesk notification rule database (112). The KPI/user post receiver (106) receives a plurality of user posts from at least one network node of the plurality of network nodes (110A-110N). The processor (102) is further configured to retrieve at least one ominidesk notification rule from the plurality of ominidesk notification rules stored in the ominidesk notification rule database. The Validator (107) validates the plurality of user posts based on the at least one ominidesk notification rule. The Notification distributor (108) sends a notification comprising the validated user posts to at least one target device in response to successful validation.

The processor (102) is configured to display a ominidesk notification rule interface comprising a network node parameter field to select network node for which the ominidesk notification rule need to be build. The processor (102) is further configured to receive an input in the network node parameter field from the at least one target device, wherein the input indicates the selection of the at least one network node form the plurality of nodes for which the ominidesk notification rule need to be build. The processor (102) is further configured to display, in the ominidesk notification rule building interface, a plurality of rule building parameters for the at least one selected network node. The processor (102) is further configured to receive input from the at least one target device corresponding to each rule building rule parameter from the plurality of rule building parameters. The processor (102) is further configured to automatically generate at least one ominidesk notification rule for the at least one selected network node based on the received input corresponding to each rule building rule parameter from the plurality of rule building parameters.

In an embodiment, the plurality of rule building parameters comprises a basic information section, a condition section, a report frequency section and a notification report media section and the at least one target devices (109A-109N) details parameter for sending the notification. The basic information section includes fields comprising a sentiment, a category, wherein the condition section includes fields comprising a criteria, a inequality and a compare with number, wherein the report frequency section includes fields comprising hours basis, daily basis, weekly basis, wherein the notification report media section includes fields comprising SMS, Email and messengers.

The processor (102) is configured to detect at least one parameters of the media type, the sentiment, the category and the criteria of the plurality of ominidesk notification rule. The processor (102) is further configured to filter the at least one ominidesk notification rule in the notification database based on at least one of the media type, the sentiment, the category and the criteria. The processor (102) is further configured to receive the plurality of user posts from the at least one network node of the plurality of network nodes (110A-110N).

The processor (102) is configured to validate the plurality of user posts from the at least one network node based on the at least one ominidesk notification rule.

The processor (102) is configured to retrieve at least one specific information present in the successfully validated user post. The processor (102) is further configured to generate the notification comprise at least one of the successfully validated user post, a hyperlink of the successfully validated user post and the at least one specific information present in the successfully validated user post. The processor (102) is further configured to determine parameters in the report frequency section and the notification report media section of the plurality of ominidesk notification rules. The processor (102) is further configured to determine the at least one target device associated with the ominidesk notification rule from the plurality of ominidesk notification rule. The processor (102) is further configured to send the notification to the at least one target device from the plurality of target devices (109A-109N), wherein the notification comprising at least one of the successfully validated user post, a hyperlink of the successfully validated user post and the at least one specific information present in the successfully validated user post in accordance with the parameters in the report frequency section and the notification report media section.

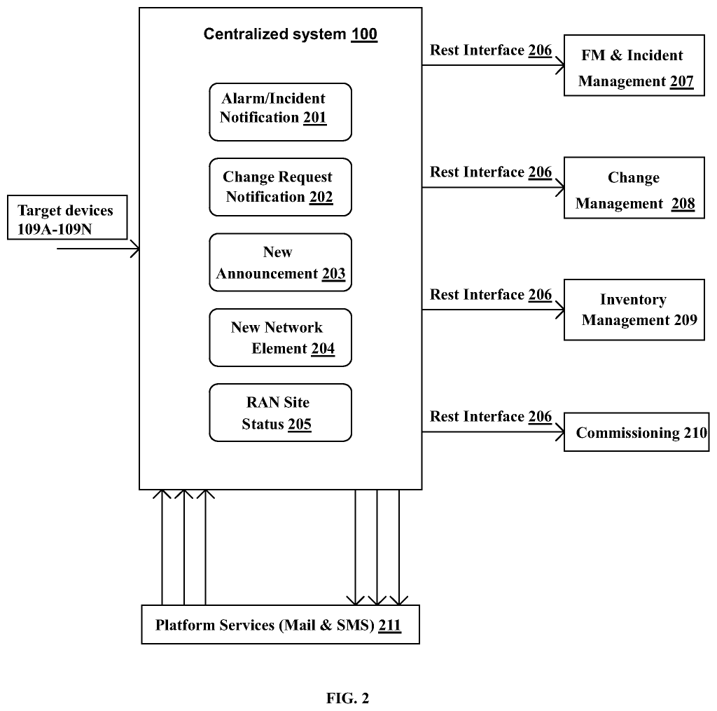

FIG. 2 is a block diagram of the centralized system (100) illustrating a communication with the plurality of network nodes (110A-110N), according to the embodiments as disclosed herein.

Referring to FIG. 2, an example of the centralized system (100) provides a comprehensive notification management solution that helps telecom organizations notify concerned parties through push notifications, email, and SMS by a platform services (211).

The centralized system (100) manages notifications with all assisted (e.g. customer care) and unassisted channels (online, mobile app, partner portal, etc.) to customers, agents, and partners. It allows the target devices (109A-109N) to configure performance notification rules to get the notification. The performance notification rule includes alarm/incident notification (201), change request notification (202), new announcement (203), new network element (204) and RAN site status 205.

Administrators can edit these messages, add new messages, and change the conditions under which the messages will be sent out, as well as select who will receive the messages. The centralized system (100) can broadcast push notifications to everyone at once or target specific users (customer devices) using the centralized system (100), which allows target devices (109A-109N) to segment users to deliver the right content to a right person at a right time. The centralized system (100) allows users to control the notification frequency and the target devices (109A-109N) can also schedule a notification based on date and time.

The centralized system (100) requires data to trigger notifications on different frequencies for different notification types, such as Fault & incident management (FM) (207), Change management (CHM) (208), Inventory Management (IM) (209) and commissioning (210), etc. the centralized system (100) sends notifications according to different notification types. Further, the operator needs to integrate domain vendor and node details on which the data is available. In the performance notification rule, user can build their own performance notification rule on top of the FM (207), the CHM (208), and the IM (209) data. The centralized system (100) reads data directly from the API such as a rest interface (206) and checks the performance notification rule.

The centralized system (100), the API-based approach for network performance monitoring, the centralized system (100) integrates network nodes (110A-110N) such as different Operational Support System (OSS) modules and manages the notification through the API. If there are any changes that occur in integrated different modules then only API parameters are changed to get the data to process and analyze the performance notification rule.

The centralized system (100) communicates directly to all the different modules and fetch the data as per the condition given by the administrator or target devices (109A-109N). The notification types like alarm, incident, and change-requests that the target devices (109A-109N) are requesting the data through an API after data receives notification processing will start.

In the API-based approach for network performance monitoring, the centralized system (100) fetches data from the different modules API for which the target devices (109A-109N) has requested by creating a notification. Notification service is loosely coupled to the system, centralized system (100) is very safest and most secure approach for the system and service, centralized system (100) will provide speedy performance and the fastest approach to get data from the different modules through the API.

A PM database is one of network nodes (110A-110N) stores the KPI information for every network element. The centralized system (100) fetches the KPI information directly from the PM database and stores it in Hbase. The Hbase is used to store the unstructured form of data which provides consistent read/write access in high-volume requests. The unstructured data is processed in apache spark due to its speed, ease of use, and dynamic nature, apache-spark is the best choice to process a large amount of data using different functions and approaches.

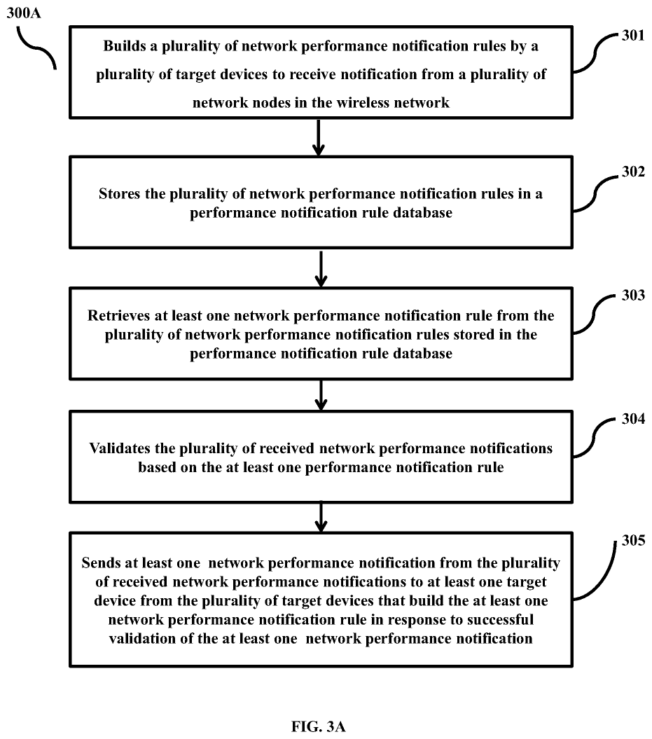

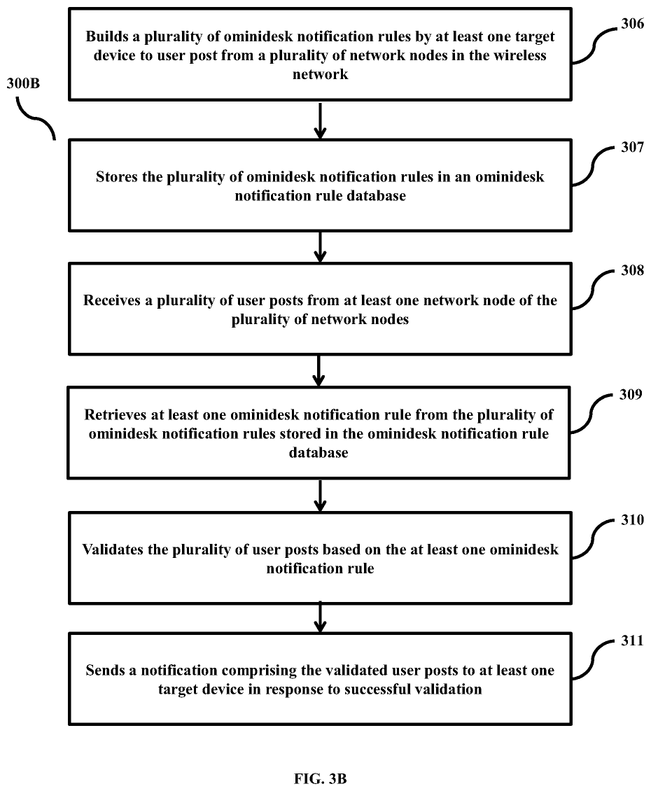

FIG. 3A is a flow chart (300A) illustrating managing notification in the wireless network (111) with the performance notification rule, according to the embodiments as disclosed herein.

At step 301, the centralized system (100) builds the plurality of network performance notification rules by the plurality of target devices (109A-109N) to receive notification from the plurality of network nodes (110A-110N) in the wireless network (111).

At step 302, the centralized system (100) stores the plurality of network performance notification rules in the performance notification rule database.

At step 303, the centralized system (100) retrieves at least one network performance notification rule from the plurality of network performance notification rules stored in the performance notification rule database.

At step 304, the centralized system (100) validates the plurality of received network performance notifications based on the at least one performance notification rule.

At step 305, the centralized system (100) sends at least one network performance notification from the plurality of received network performance notifications to at least one target device from the plurality of target devices (109A-109N) that build the at least one network performance notification rule in response to successful validation of the at least one network performance notification.

The various actions, acts, blocks, steps, or the like in the method may be performed in the order presented, in the different order or simultaneously. Further, in some embodiments, some of the actions, acts, blocks, steps, or the like may be omitted, added, modified, skipped, or the like without departing from the scope of the invention.

FIG. 3B is the flow chart (300B) illustrating managing notification in the wireless network (111) with the ominidesk notification rule, according to the embodiments as disclosed herein.

At step 306, the centralized system (100) builds the plurality of ominidesk notification rules by at least one target device to user post from the plurality of network nodes (110A-110N) in the wireless network (111).

At step 307, the centralized system (100) stores the plurality of ominidesk notification rules in the ominidesk notification rule database.

At step 308, the centralized system (100) receives the plurality of user posts from at least one network node of the plurality of network nodes (110A-110N).

At step 309, the centralized system (100) retrieves at least one ominidesk notification rule from the plurality of ominidesk notification rules stored in the ominidesk notification rule database.

At step 310, the centralized system (100) validates the plurality of user posts based on the at least one ominidesk notification rule.

At step 311, the centralized system (100) sends the notification comprising the validated user posts to at least one target device in response to successful validation.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

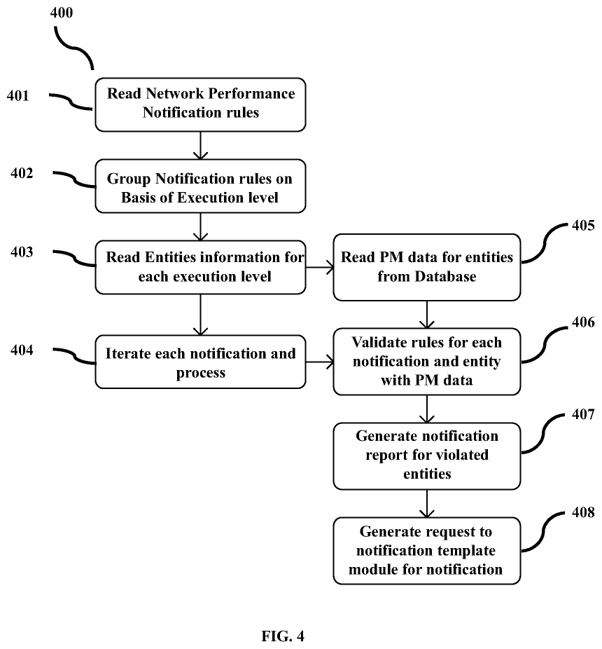

FIG. 4 is a flow chart (400) illustrating generating notifications related to network performance, according to the embodiments as disclosed herein.

At step 401, target devices (109A-109N) can build performance notification rules on top of a performance management (PM) data such as PM, FM, CHM. The centralized system (100) reads data directly from other application databases and checking rules. The centralized system (100) after creating the performance notification rule from a User Interface (UI), the centralized system (100) checks and read the notification rule from the notification database.

At step 402, the centralized system (100) after reading the notification rule groups all the performance notification rules according to an execution level.

At step 403, the centralized system (100) after checking the execution level that reads network element data from the database. After reading the network element data, the centralized system (100) at step 404, gets the KPI information from the PM data.

At step 404, the centralized system (100) iterate/process the performance notification rule.

At step 406, the centralized system (100) validates the notification rule with the PM data.

At step 407, the centralized system (100) after validating the performance notification rules generates the report when the given condition is breached.

At step 408, the centralized system (100) generates request to notification template module for sending notifications. The centralized system (100) will send notifications via Email or SMS or Microsoft teams based on the option selected by the target devices (109A-109N).

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

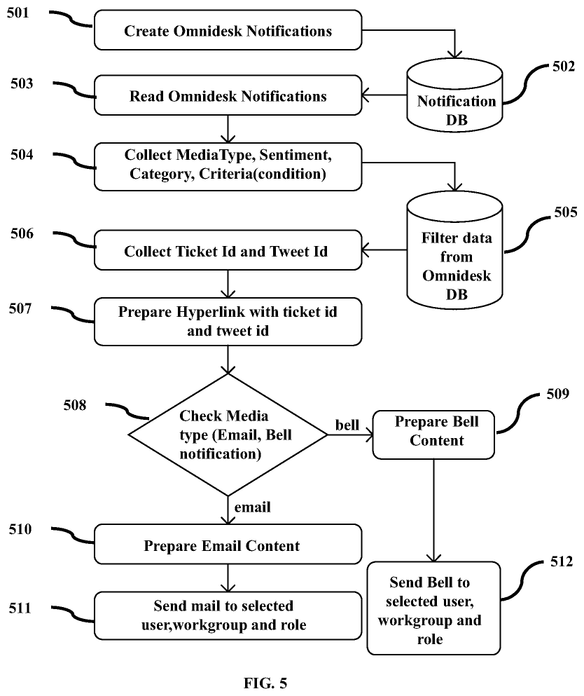

FIG. 5 is a flow chart illustrating generating notifications related to posts posted in the social media using omnidesk notification rules, according to the embodiments as disclosed herein;

At step 501, target devices (109A-109N) build their own rule on top of omnidesk data in the centralized system (100), where the omnidesk data comprises post information posted in the social networking sites.

At step 502, the centralized system (100) checks and read the notification rule from a notification database at step 502, after the omnidesk notification rule are created in the UI of the centralized system (100)

At step 504, the centralized system (100) collects a media type, a sentiment, a category, and a criteria. The media type such as e-mail, bell, or SMS. The sentiment such as tweet sentiments like positive, negative, and neutral. The category such as tweet category represents the tweet intention example campaign-related, network-call-link quality, UI-UX system, Article, etc. The criteria such as filters the tweet according to conditions like my follower should be greater than 1000 or 100, my tweet content contains “Rakuten UI was down” and others.

At step 505, the centralized system (100) filters data from the omnidesk database based on conditions in the omnidesk notification rule and collects ticket ID and tweet ID at step 506.

At step 507, the centralized system (100) prepares hyperlinks after getting data from the omnidesk database, the centralized system (100) generates hyperlinks with the ticket id and the tweet id.

At step 508, the centralized system (100) checks whether the media type is email or bell notification.

At step 510 and 511, the centralized system (100) prepares email content and template type for omnidesk notification when the media type is email notification. The centralized system (100) checks role, users, and workgroup for sending notifications.

At step 509 and 512, the centralized system (100) prepares bell content and template type for omnidesk notification when the media type is bell notification. The centralized system (100) checks role, users, and workgroup for sending notifications.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

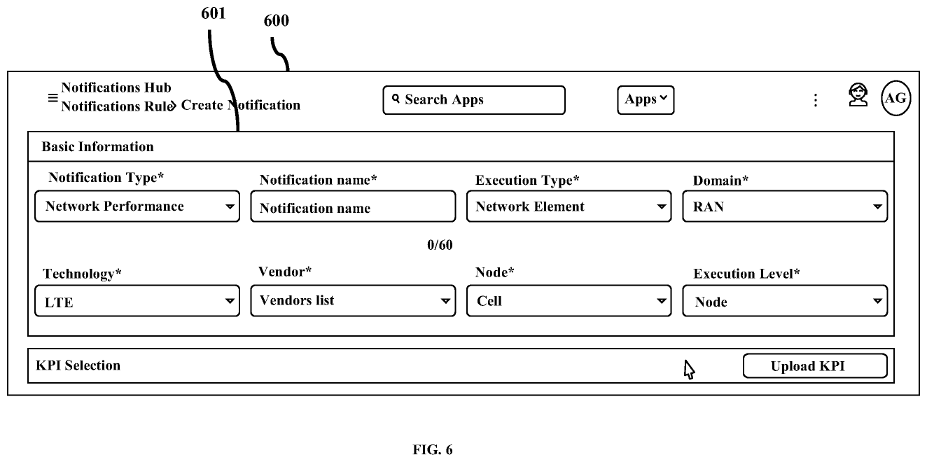

FIG. 6 is a schematic diagram illustrating a UI (600) of the centralized system (100) while configuring the network performance rules, according to the embodiments as disclosed herein; and

The centralized system (100) provides concise and correct information about degradation and poor performance of any KPI by scheduling any notification. This notification read KPI data from different database like YSQL, hbase and Treno. This notification is then further processed and sent to users via different communication channels like SMS and Microsoft Teams including Email service.

The target devices (109A-109N) builds the plurality of performance notification rule in the UI (600) to receive notification from a plurality of network nodes (110A-110N). The UI displays various options (601) for selecting the performance notification rules.

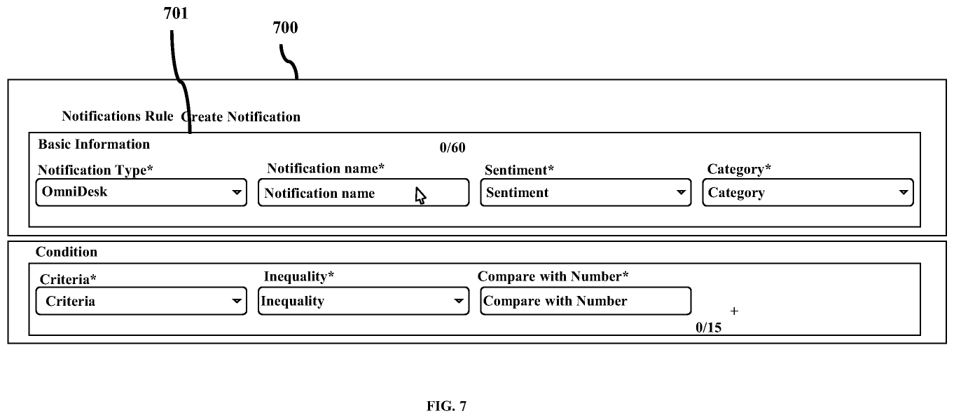

FIG. 7 is a schematic diagram illustrating the UI (700) of the centralized system (100) while configuring the ominidesk notification rules, according to the embodiments as disclosed herein

The target devices (109A-109N) can configure the notification based on the category and sentiments of tweets reported on twitter using the UI (700). The centralized system (100) gets read through a database where all the twitter post-related information is stored based on different categories and sentiments defined. As shown in various options (701) of the FIG. 7, the target devices (109A-109N) can configure each notification for a different type of frequency like hourly, daily, weekly and others. The notification will be sent to the target devices (109A-109N) that has requested the same. The centralized system (100) process notifications using the various options (701) like categories, sentiments, and conditions.

The omnidesk database stores all tweet information. The centralized system (100) fetches the tweet information to filter the tweet id and ticket id. The centralized system (100) compares sentiment, category, and condition directly from the omnidesk database. The centralized system (100) prepares hyperlinks and mail content based on frequency and media type and sends notification via different communication channels like Email, SMS, and Bell Notification.

The proposed method and system have the following advantages:
1. The proposed system can communicate directly to all other modules or network nodes (110A-110N) for which the users wants notification
2. The proposed system and method can manage notifications centrally which reduces time in configuring user preferences separately at network nodes (110A-110N)
3. The proposed system can provide notifications via Microsoft teams, SMS, email, and others.
4. The proposed system can provide frequency-based alerts/notifications where the users can configure each notification for a different type of frequency like Hourly, Daily, Weekly, and others.
5. The proposed system validates the KPI information of network nodes (110A-110N) which helps to monitor the performance of the network nodes (110A-110N)
6. The proposed system can validate the plurality of user posts receive from the network nodes (110A-110N) and send a notification comprising the validated user posts to the target devices (109A-109N) which saves time in filtering content present in the network nodes (110A-110N)

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A centralized system for managing notifications in a wireless network, wherein the centralized system comprises:
a memory; and
a processor, communicatively coupled to the memory, configured to:
build a plurality of network performance notification rules by a plurality of target devices to receive notification from a plurality of network nodes in the wireless network;
store the plurality of network performance notification rules in a performance notification rule database;
receive a plurality of network performance notifications from a plurality of network nodes;
retrieve at least one network performance notification rule from the plurality of network performance notification rules stored in the performance notification rule database;
validate the plurality of received network performance notifications based on the at least one performance notification rule; and
send at least one network performance notification from the plurality of received network performance notifications to at least one target device from the plurality of target devices that build the at least one network performance notification rule in response to successful validation of the at least one network performance notification.

2. The centralized system as claimed in claim 1, wherein build the plurality of network performance notification rule by the plurality of target devices comprises:
display a performance notification rule building interface comprising a network node parameter field to select network node for which the performance notification rule need to be build;
receive an input in the network node parameter field from the at least one target device, wherein the input indicates the selection of the at least one network node form the plurality of nodes for which the performance notification rule need to be build;
display, in the performance notification rule building interface, a plurality of rule building parameters for the at least one selected network node, at least one KPI parameter supported by the at least one selected network node and an execution level for the at least one selected network node;
receive input from the at least one target device corresponding to each rule building rule parameter from the plurality of rule building parameters, the at least one KPI parameter supported by the at least one selected network node, and the execution level for the at least one selected network node; and
automatically generate at least one network performance notification rule for the at least one selected network node based on the received input corresponding to each rule building rule parameter from the plurality of rule building parameters, the KPI parameter supported by the at least one selected network node.

3. The centralized system as claimed in claim 1, wherein receive the plurality of network performance notifications from a plurality of network nodes comprises:
detect an execution level for each network performance notification of the plurality of network performance notifications;
group a set of performance notification of the plurality of network performance notifications having the same execution level information into a group;
detect at least one network node from the plurality of network nodes for the execution level and the group of performance notifications;
retrieve KPI information from the at least one detected network node for the execution level.

4. The centralized system as claimed in claim 1, wherein validate the plurality of received network performance notifications based on the at least one performance notification rule comprises:
validate the plurality of received network performance notifications and the KPI information from the at least one detected network node based on the at least one performance notification rule.

5. The centralized system as claimed in claim 1, wherein the processor configured to generate a notification report for at least one network performance notification from the plurality of received network performance notifications and the KPI information from the at least one detected network node in response to unsuccessful validation.

6. The centralized system as claimed in claim 1, wherein send at least one network performance notification from the plurality of received network performance notifications to the at least one target device from the plurality of target devices comprises:
determine parameters in a report frequency information section and a notification report medium section of the at least one performance notification rule;
determine the at least one target device from the plurality of target device associated with the KPI information corresponding to the at least one network performance notification rule;
send at least one network performance notification comprising the KPI information to the at least one target device from the plurality of target devices in accordance with the parameters in the report frequency information section and the notification report medium section.

7. The centralized system as claimed in claim 2, wherein the plurality of rule building parameters comprises the report frequency section, the notification report medium section, a location section, a notification assignment section and at least one target devices details parameter for sending the notification,
wherein the report frequency section includes fields comprising hours basis, daily basis, weekly basis, wherein the notification report medium section includes fields comprising SMS, Email, messengers, wherein the location section includes fields comprising region, city, cluster, equipment type, wherein the notification assignment section includes fields comprising channel name and channel URL.

8. The centralized system as claimed in claim 2, wherein the at least one KPI parameter rule building parameters comprises a basic information parameters and a KPI selection parameters, wherein the basic information parameters includes fields comprising execution type, domain, technology, vendor, node and execution level, wherein the KPI selection parameters includes fields comprises KPI name and KPI group.

9. A centralized system for managing notifications in a wireless network, wherein the centralized system comprises:
a memory; and
a processor, communicatively coupled to the memory, configured to:
build a plurality of ominidesk notification rules by at least one target device to user post from a plurality of network nodes in the wireless network;
store the plurality of ominidesk notification rules in an ominidesk notification rule database;
receive a plurality of user posts from at least one network node of the plurality of network nodes;
retrieve at least one ominidesk notification rule from the plurality of ominidesk notification rules stored in the ominidesk notification rule database;
validate the plurality of user posts based on the at least one ominidesk notification rule; and
send a notification comprising the validated user posts to at least one target device in response to successful validation.

10. The centralized system as claimed in claim 9, wherein build a plurality of ominidesk notification rules by at least one target device to user post from a plurality of network nodes in the wireless network comprises:
display a ominidesk notification rule interface comprising a network node parameter field to select network node for which the ominidesk notification rule need to be build;
receive an input in the network node parameter field from the at least one target device, wherein the input indicates the selection of the at least one network node form the plurality of nodes for which the ominidesk notification rule need to be build;
display, in the ominidesk notification rule building interface, a plurality of rule building parameters for the at least one selected network node;
receive input from the at least one target device corresponding to each rule building rule parameter from the plurality of rule building parameters; and
automatically generate at least one ominidesk notification rule for the at least one selected network node based on the received input corresponding to each rule building rule parameter from the plurality of rule building parameters.

11. The centralized system as claimed in claim 10, wherein the plurality of rule building parameters comprises a basic information section, a condition section, a report frequency section and a notification report media section and the at least one target devices details parameter for sending the notification,
wherein the basic information section includes fields comprising a sentiment, a category, wherein the condition section includes fields comprising a criteria, a inequality and a compare with number, wherein the report frequency section includes fields comprising hours basis, daily basis, weekly basis, wherein the notification report media section includes fields comprising SMS, Email and messengers.

12. The centralized system as claimed in claim 9, wherein receive a plurality of user posts from at least one network node of the plurality of network nodes comprises:
detect at least one parameters of the media type, the sentiment, the category and the criteria of the plurality of ominidesk notification rule;
filter the at least one ominidesk notification rule in the notification database based on at least one of the media type, the sentiment, the category and the criteria;
receive the plurality of user posts from the at least one network node of the plurality of network nodes.

13. The centralized system as claimed in claim 9, wherein validate the plurality of user posts based on at least one ominidesk notification rule from the plurality of ominidesk notification rule comprises:
validate the plurality of user posts from the at least one network node based on the at least one ominidesk notification rule.

14. The centralized system as claimed in claim 9, wherein send a notification comprising the validated user posts to the at least one target device in response to successful validation comprises:
retrieve at least one specific information present in the successfully validated user post;
generate the notification comprise at least one of the successfully validated user post, a hyperlink of the successfully validated user post and the at least one specific information present in the successfully validated user post;
determine parameters in the report frequency section and the notification report media section of the plurality of ominidesk notification rules;
determine the at least one target device associated with the ominidesk notification rule from the plurality of ominidesk notification rule;
send the notification to the at least one target device from the plurality of target devices, wherein the notification comprising at least one of the successfully validated user post, a hyperlink of the successfully validated user post and the at least one specific information present in the successfully validated user post in accordance with the parameters in the report frequency section and the notification report media section.

15. A method for managing notifications in a wireless network by a centralized system, comprises:
building, by the centralized system, a plurality of network performance notification rules by a plurality of target devices to receive notification from a plurality of network nodes in the wireless network;
storing, by the centralized system, the plurality of network performance notification rules in a performance notification rule database;
receiving, by the centralized system, a plurality of network performance notifications from a plurality of network nodes;
retrieving, by the centralized system, at least one network performance notification rule from the plurality of network performance notification rules stored in the performance notification rule database;
validating, by the centralized system, the plurality of received network performance notifications based on the at least one performance notification rule; and
sending, by the centralized system, at least one network performance notification from the plurality of received network performance notifications to at least one target device from the plurality of target devices that build the at least one network performance notification rule in response to successful validation of the at least one network performance notification.

16. A method for managing notifications in a wireless network by a centralized system, comprises:
building, by the centralized system, a plurality of ominidesk notification rules by at least one target device to user post from a plurality of network nodes in the wireless network;
storing, by the centralized system, the plurality of ominidesk notification rules in an ominidesk notification rule database;
receiving, by the centralized system, a plurality of user posts from at least one network node of the plurality of network nodes;
retrieving, by the centralized system, at least one ominidesk notification rule from the plurality of ominidesk notification rules stored in the ominidesk notification rule database;
validating, by the centralized system, the plurality of user posts based on the at least one ominidesk notification rule; and
sending, by the centralized system, a notification comprising the validated user posts to at least one target device in response to successful validation.
